(19) United States
(12) Patent Application Publication
(10) Pub. No.: US 2026/0237108 A1
(43) Pub. Date: Aug. 13, 2026

(54) WINDOWED ATTENTION FOR TEXT-TO-VIDEO GENERATION

(71) Applicant: ADOBE INC., SAN JOSE, CA (US)

(72) Inventors: Zhiwen Cao, San Jose, CA (US); Ratheesh Kalarot, Hayward, CA (US); Mamshad Nayeem Rizve, Cupertino, CA (US); Kevin Duarte, San Jose, CA (US)

(21) Appl. No.: 19/369,496

(22) Filed: Oct. 27, 2025

Related U.S. Application Data
(60) Provisional application No. 63/755,461, filed on Feb. 7, 2025.

(51) Int. Cl. G06T 11/00; G06N 3/045

(52) U.S. Cl. CPC G06T 11/00; G06N 3/045

(57) ABSTRACT

A method, apparatus, non-transitory computer readable medium, and system for video generation includes obtaining an input prompt describing a scene. A video generation model generates a global token based on the input prompt by performing an attention process based on a plurality of frame tokens. The video generation model generates a frame token by performing an attention process based on the global token and a subset of the plurality of frame tokens in a local window. Subsequently, the video generation model generates a synthetic video based on the frame token, wherein the synthetic video depicts the scene and includes an image frame corresponding to the frame token.

### CROSS-REFERENCE TO RELATED APPLICATION

This application is based on and claims priority under 35 U.S.C. § 120 to U.S. Patent Application No. 63/755,461, filed on Feb. 7, 2025, in the United States Patent and Trademark Office, the contents of which are incorporated by reference herein in their entirety.

### BACKGROUND

The following generally relates to machine learning, and more specifically to video generation using a machine learning model. Machine learning algorithms build a model based on sample data, known as training data, to make a prediction or a decision in response to an input without being explicitly programmed to do so. One area of application for machine learning is video generation.

For example, a machine learning model can be trained to predict features for a video in response to an input prompt, and then generate the video based on the predicted features. In some cases, the prompt can be used to perform complex video manipulation and compositing. Such video generation provides for a user to edit a video and generate a modified video with desired features and therefore makes video generation easier for a layperson.

### SUMMARY

The present disclosure describes systems and methods for video generation. Embodiments of the present disclosure are configured to generate a high-resolution video based on an input prompt. In some cases, a video generation model of the present disclosure is configured to implement a windowed self-attention mechanism in a video based diffusion network. According to an embodiment, the video generation model is configured to perform a global update followed by a local update. For instance, the video generation model updates a register token, a video token, and a text token based on the input prompt and a set of video frames associated with a video.

A method, apparatus, and non-transitory computer readable medium for video processing are described. One or more aspects of the method, apparatus, and non-transitory computer readable medium include obtaining an input prompt describing a scene; generating, using a video generation model, a global token based on the input prompt by performing an attention process based on a plurality of frame tokens; generating, using the video generation model, a frame token by performing an attention process based on the global token and a subset of the plurality of frame tokens in a local window; and generating, using the video generation model, a synthetic video based on the frame token, wherein the synthetic video depicts the scene and includes an image frame corresponding to the frame token.

A method, apparatus, and non-transitory computer readable medium for video processing are described. One or more aspects of the method, apparatus, and non-transitory computer readable medium include obtaining an input prompt describing a scene; generating a text token based on the input prompt; generating, using a video generation model, a frame token by performing an attention process based on the text token and a subset of a plurality of frame tokens in a local window; and generating, using the video generation model, a synthetic video based on the frame token, wherein the synthetic video depicts the scene and includes an image frame corresponding to the frame token.

An apparatus and system for video processing are described. One or more aspects of the apparatus and system include obtaining an input prompt describing a scene; generating, using a video generation model, a global token based on the input prompt by performing an attention process based on a plurality of frame tokens; generating, using the video generation model, a frame token by performing an attention process based on the global token and a subset of the plurality of frame tokens in a local window; and generating, using the video generation model, a synthetic video based on the frame token, wherein the synthetic video depicts the scene and includes an image frame corresponding to the frame token.

### BRIEF DESCRIPTION OF THE DRAWINGS

FIG. 1 shows an example of a video processing system according to aspects of the present disclosure.

FIG. 2 shows an example of a method for video generation according to aspects of the present disclosure.

FIG. 3 shows an example of a video generation process according to aspects of the present disclosure.

FIG. 4 shows an example of a video generation model according to aspects of the present disclosure.

FIG. 5 shows an example of a transformer architecture according to aspects of the present disclosure.

FIG. 6 shows an example of a latent diffusion process according to aspects of the present disclosure.

FIG. 7 shows an example of a diffusion transformer network according to aspects of the present disclosure.

FIG. 8 shows an example of a diffusion transformer network for a video according to aspects of the present disclosure.

FIG. 9 shows an example of a denoising diffusion process according to aspects of the present disclosure.

FIG. 10 shows an example of a method for video processing according to aspects of the present disclosure.

FIG. 11 shows an example of a method for video processing according to aspects of the present disclosure.

FIG. 12 shows an example of a method for video processing according to aspects of the present disclosure.

FIG. 13 shows an example of a method for video processing according to aspects of the present disclosure.

FIG. 14 shows an example of a method of training a machine learning model according to aspects of the present disclosure.

FIG. 15 shows an example of a method of training a diffusion model according to aspects of the present disclosure.

FIG. 16 shows an example of a computing device according to aspects of the present disclosure.

FIG. 17 shows an example of a video processing apparatus according to aspects of the present disclosure.

### DETAILED DESCRIPTION

Existing systems use a diffusion network for video generation. In some cases, existing video generation models use a transformer network with self-attention mechanism. For instance, such systems are able to incorporate some spatial information in the generated video. However, in cases where the generated video has a high resolution, such systems fail to capture the global and spatial dependencies in the generated video.

Additionally, in some cases, existing video generation systems are limited in terms of scalability as the generated video increases in resolution. In some cases, an existing system becomes computationally challenged when dealing with real-world scenarios that use long duration videos that are also high in resolution. As a result, such systems have limited effectiveness and often depict poor temporal coherence and spatial detail in the generated video.

By contrast, embodiments of the present disclosure are configured to generate a high-resolution video based on an input text prompt. In some cases, a video generation model of the present disclosure is configured to implement a windowed self-attention mechanism in a video based diffusion network. According to an embodiment, the video generation model is configured to perform a global update and a local update. For instance, the video generation model updates a register token, an image token, a video token, and a text token based on an input prompt and a set of video frames associated with a video.

The present disclosure describes systems and methods for video generation. Embodiments of the present disclosure are configured to perform a windowed attention mechanism for a diffusion network. In some cases, a video generation model of the present disclosure is based on the diffusion network. In some cases, the video generation model is configured to perform a partition of a video sequence. For example, the video generation model performs the partitioning to generate one or more non-overlapping temporal videos. In some examples, a size or a duration of the non-overlapping temporal videos is less than a size or a duration of the input video sequence.

In some cases, the video generation model comprising the diffusion network is configured to perform the self-attention mechanism on each of the one or more non-overlapping temporal videos. In some cases, the video generation model is able to capture fine-grained temporal dynamics for each of the one or more non-overlapping temporal videos.

Embodiments of the present disclosure are configured to perform a non-overlapping windowed attention mechanism. In some cases, the video generation model of the present disclosure modifies a size of the window. For example, the video generation model reduces complexity associated with the window size based on a linear variation. In some examples, the video generation model performs partitioning of the input video sequence based on a variable window size. In some examples, the size of the window at each attention layer of the video generation model is variable.

In some cases, by varying the size of the window at each attention layer, embodiments of the present disclosure are used to optimize efficiency and performance of the video generation model. Additionally, in some cases, the variation in the size of the window at each attention layer is used to enable efficient processing of a high-resolution video.

An embodiment of the present disclosure is configured to perform video generation. In some cases, the video generation model is used to learn a global token and a global context. For example, the video generation model learns the global token from a key frame associated with each of the one or more non-overlapping temporal videos. For example, the video generation model learns the global context from the key frame associated with each of the one or more non-overlapping temporal videos. By using the video generation model to learn the global tokens and context from the key frames, embodiments of the present disclosure are able to efficiently propagate global context for video generation.

In some cases, the global token is considered a compact representation of the input video sequence. For example, the global token captures long-range dependencies based on the input video sequence. Accordingly, by incorporating learnable global tokens from the key frame associated with each of the one or more non-overlapping temporal videos, embodiments of the present disclosure are able to capture long-range dependencies while reducing the computational cost associated with a self-attention mechanism.

In some cases, a context of the key frame associated with each of the one or more non-overlapping temporal videos ensures temporal consistency. For example, the key frame context ensures temporal consistency across the windows at each attention layer. Accordingly, by capturing keyframe context for temporal consistency across the windows, embodiments of the present disclosure are able to prevent artifacts in the generated video. Additionally, by ensuring the temporal consistency, embodiments are able to prevent disjointed transitions between the set of video frames.

Embodiments of the present disclosure are configured to perform a video generation process. In some cases, the video generation model of the present disclosure is configured to vary a window size at different attention layers of the diffusion network. For example, by varying the window sizes at the different attention layers, embodiments of the present disclosure are able to optimize efficiency and performance of video generation.

An embodiment of the present disclosure is configured to implement a learnable register token during the video generation process. In some cases, the video generation model uses the learnable register tokens (i.e., global tokens) to propagate global context between the windows at each attention layer of the diffusion network. In some cases, the video generation model is configured to generate a synthetic video based on the diffusion network architecture.

An embodiment of the present disclosure is configured to incorporate a context from a key frame associated with each of the one or more non-overlapping temporal videos. In some cases, the video generation model is used to implement the context from a nearby key frame. For example, the nearby key frame refers to a key frame (or a plurality of key frames) in proximity of the current window. In some cases, the video generation model is used to implement a context from a shifting window across the attention layers. For example, the windows are shifted across the attention layers of the video generation model comprising the diffusion network. By incorporating the context from the nearby key frames and the shifting windows, embodiments of the present disclosure are able to ensure consistency and efficient propagation of global context across the diffusion network architecture of the video generation model.

As used herein, an input prompt refers to a textual or natural language based instruction that guides or conditions the video generation process. For example, the input prompt describes a scene the user wants to depict in the synthetic video. In some cases, the input prompt is encoded using a text encoder to generate a token, which serves as a conditioning signal for a downstream module, such as a video generation model. The video generation model may use the prompt to determine scene composition, object placement, temporal progression, or stylistic attributes of the generated content.

In some cases, transformer-based diffusion models operate by performing attention operations on tokens, which are a sequence of vectors that represent the video being generated. In some cases, the tokens represent patches of the image, where each patch is iteratively denoised to generate image content, and after the denoising is complete, the patches are reconstructed to form the final video. In some cases, some tokens may need fewer processing operations than others during the iterative generation process of a video.

As described herein, a key frame in a video segment refers to a significant frame in a sequence of video frames that serves as a reference for frame interpolation, while ensuring temporal coherence. For example, the key frame may refer to a first frame in a block of frames, where the key frame includes block information, such as, but not limited to, pixel information.

In some cases, a frame token refers to a data representation that identifies or encodes a frame within a sequence of video frames. In some cases, the frame token is used as a reference point for subsequent frames. For example, the frame token comprises motion information related to the video frames in the block.

In some cases, a global token refers to a proxy token. In some cases, the global token may not be part of the video and may refer to an additional parameter to be optimized in the network. In some cases, the global tokens are used to perform message passing. In some examples, the global token may refer to a register token that comprises information for different input tokens. For example, the global token may include a learnable embedding that interacts with the input tokens via attention mechanisms during processing. The global token attends to and is attended by other tokens (e.g., text token, frame token, etc.), thereby accumulating contextual information across the sequence.

As used herein, a video generation model may refer to a machine learning-based model configured to generate a media item, such as a video, based on input data. The model may include machine learning architectures, such as neural networks, generative adversarial networks (GANs), transformer-based models, or a diffusion network. In some cases, the video generation model may utilize trained parameters, latent representations, or probabilistic sampling techniques to generate an output that resembles or extends the input data while maintaining desired stylistic or structural attributes.

As used herein, an attention process refers to a mechanism that determines how much each token in a sequence should influence the representation of another token when computing contextual embeddings. For example, in some cases each token is first projected into three vectors: a query (Q), a key (K), and a value (V). The model computes a similarity between a token's query and other token's key (e.g., using a scaled dot product scaled), applies a softmax to obtain normalized attention weights, and then forms a weighted sum of the value vectors. This process enables models to dynamically focus on the most relevant parts of the input for each position, capturing dependencies across arbitrary distances in the sequence. In some embodiments, multiple attention heads perform this in parallel with different learned projections, allowing a transformer to capture diverse relational patterns simultaneously. According to embodiments of the disclosure, the scope of influence for a token can be influenced by the tokens that are used in an attention process. For example, some tokens may learn representations based on a global context and other tokens may learn a more local context (e.g., by using fewer tokens in the attention process).

As described herein, a synthetic video refers to a time-ordered sequence of frames, or images. In some cases, the synthetic video depicts a temporally coherent sequence of image frames synthesized based on the input prompt. The synthetic video reflects both spatial structure and temporal dynamics, such as motion continuity, object persistence, and scene transitions, generated based on the video generation model.

Embodiments of the disclosure improve the efficiency of conventional machine learning models. For example, by partitioning a video into a set of non-overlapping videos, embodiments of the present disclosure enable localized computation of an attention information which results in significant reduction of the computational overhead. Additionally, by performing a windowed attention mechanism on the non-overlapping temporal videos to learn the global context, embodiments of the present disclosure are able to capture fine-grained spatial information for the generated video, resulting in enhanced generation efficiency, scalability, and resolution quality. By combining the windowed attention mechanism, global tokens, and key frame context, embodiments of the present disclosure are able to provide a scalable and efficient framework for video generation while enhancing computational efficiency and video quality.

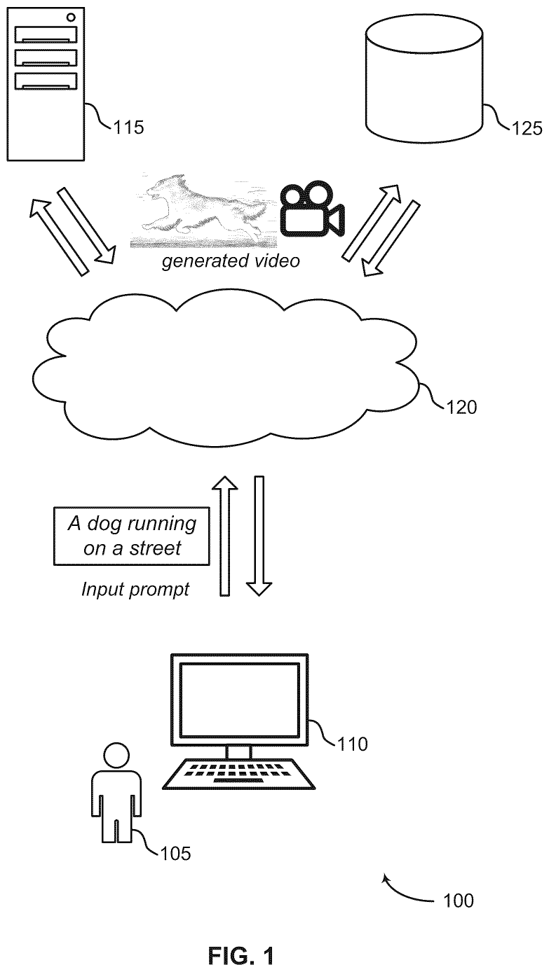

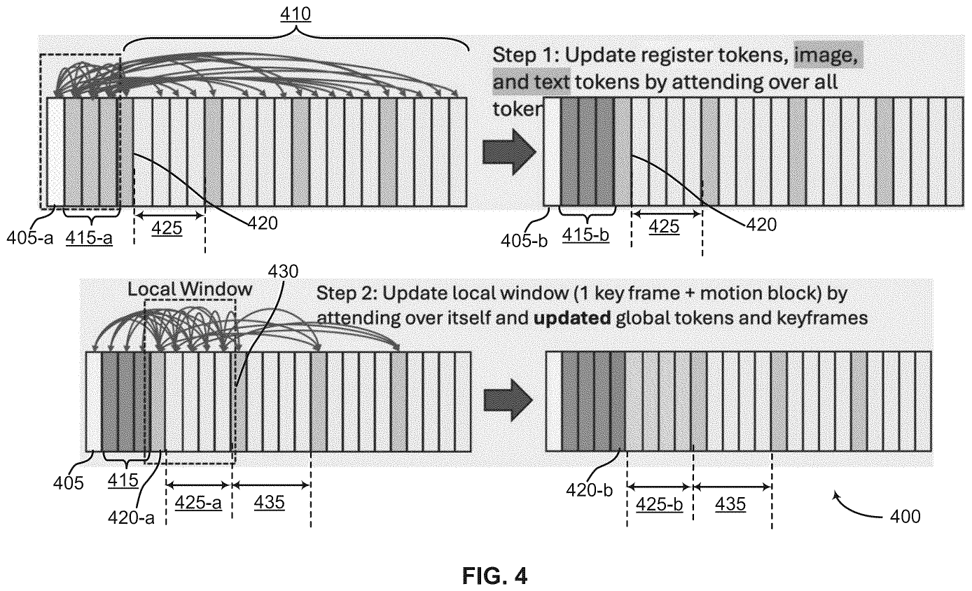

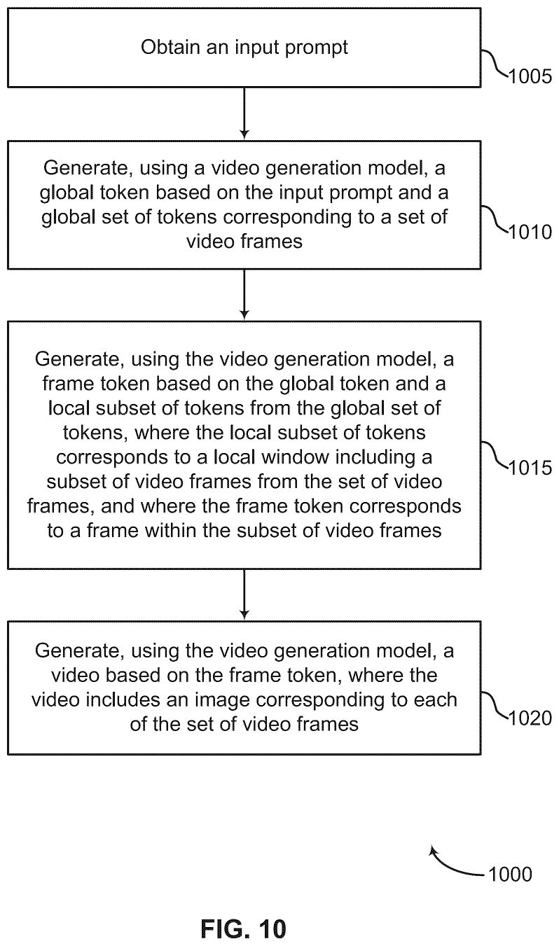

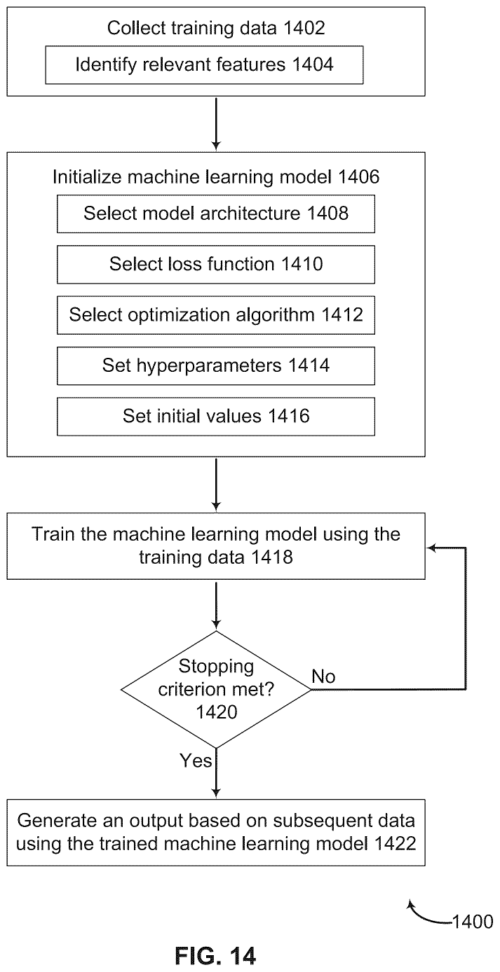

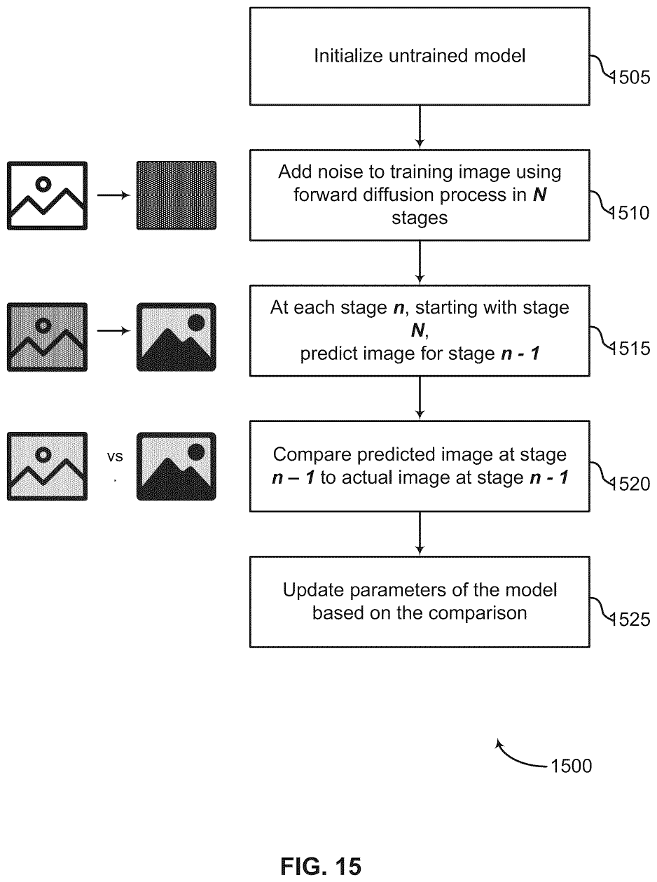

Embodiments of the present disclosure can be implemented in a video processing system. For example, the video processing system based on the present disclosure takes an input prompt (e.g., describing a target action) and generates an output video that accurately depicts the target action described in the input prompt. Example applications regarding generating a video that depicts an element are provided with reference to FIGS. 1-3. Details regarding the architecture of the video generation model are provided with reference to FIGS. 4-9 and 16-17. Details regarding an operation of the video generation model are provided with reference to FIGS. 10-13. Examples of a process for training the video generation model are provided with reference to FIGS. 14-15.

### Video Generation System

A system and an apparatus for video processing are described with reference to FIGS. 1-9. FIG. 1 shows an example of a video processing system 100 according to aspects of the present disclosure. In one aspect, video processing system 100 includes user 105, user device 110, video processing apparatus 115, cloud 120, and database 125.

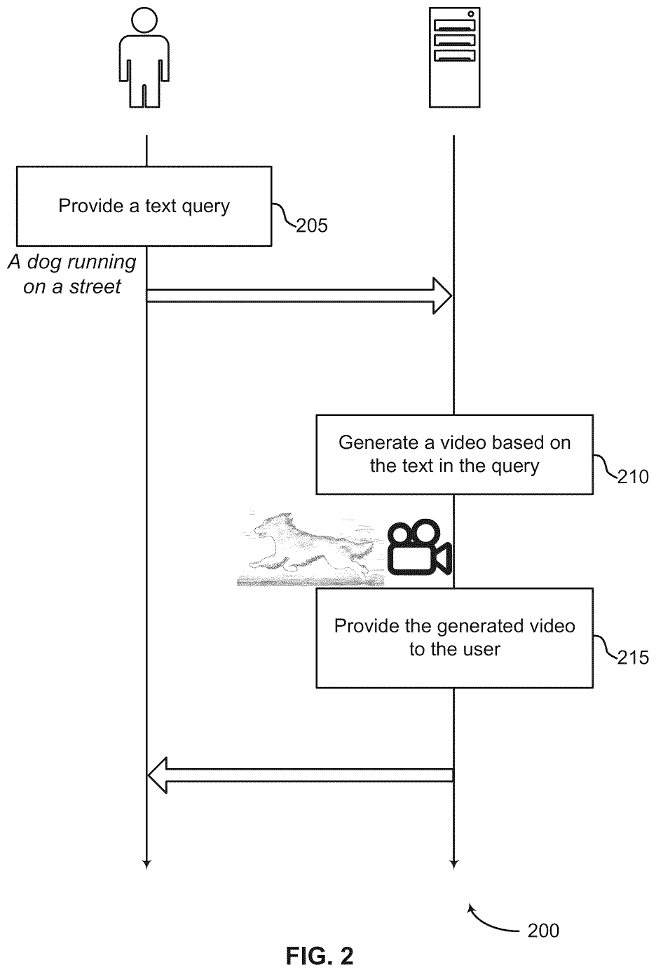

In the example of FIG. 1, user provides a prompt with an action (e.g., running) to video processing apparatus 115 via a user interface provided on user device 110 by video processing apparatus 115. In some examples, the input prompt is an input text (such as shown in FIGS. 1-2). As shown in FIG. 1, the input prompt is a text that provides details on an element and an action (e.g., “a dog running on a street”) based on which the user wants to generate a video using the video processing apparatus 115 of the present disclosure.

In some cases, the video processing apparatus 115 implements a video generation model (such as the video generation model described with reference to at least FIGS. 4-9) to generate a video that is based on the input prompt. In some cases, as shown in FIG. 1, the user provides an input prompt (e.g., a text query) to the video processing apparatus 115, aspects of which the user wants to depict in the video. In some examples, the video processing apparatus generates a video that accurately aligns with the information provided by the input prompt.

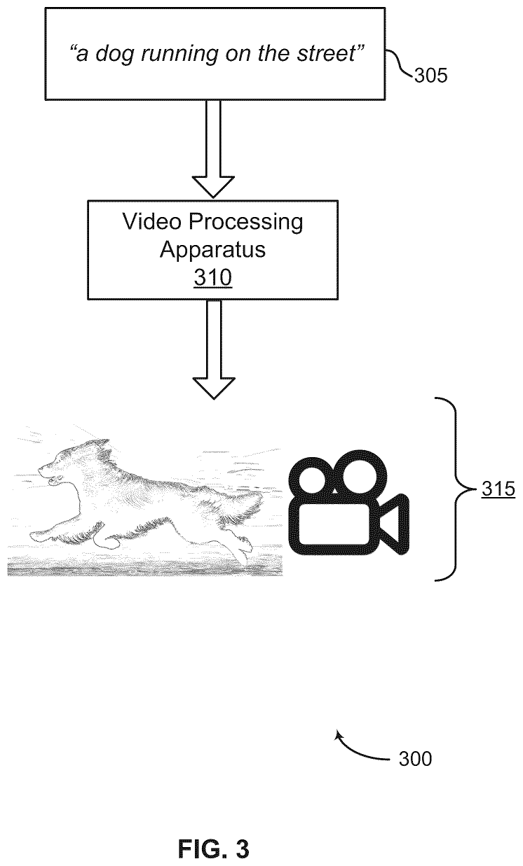

In some examples, the video processing apparatus generates the video that is spatially consistent and accurately captures fine-grained temporal dynamics based on an efficient propagation of global context during video generation. Video processing apparatus 115 is an example of, or includes aspects of, the corresponding element described with reference to FIG. 3.

Referring again to the example of FIG. 1, the video processing apparatus 115 generates the video that accurately depicts (or modifies) an aspect (e.g., element) described by the input prompt. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by video processing apparatus 115. In some aspects, the user interface provides for information (such as videos (an input video or a generated video), images, a prompt, a canvas, etc.) to be communicated between user 105 and video processing apparatus 115.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

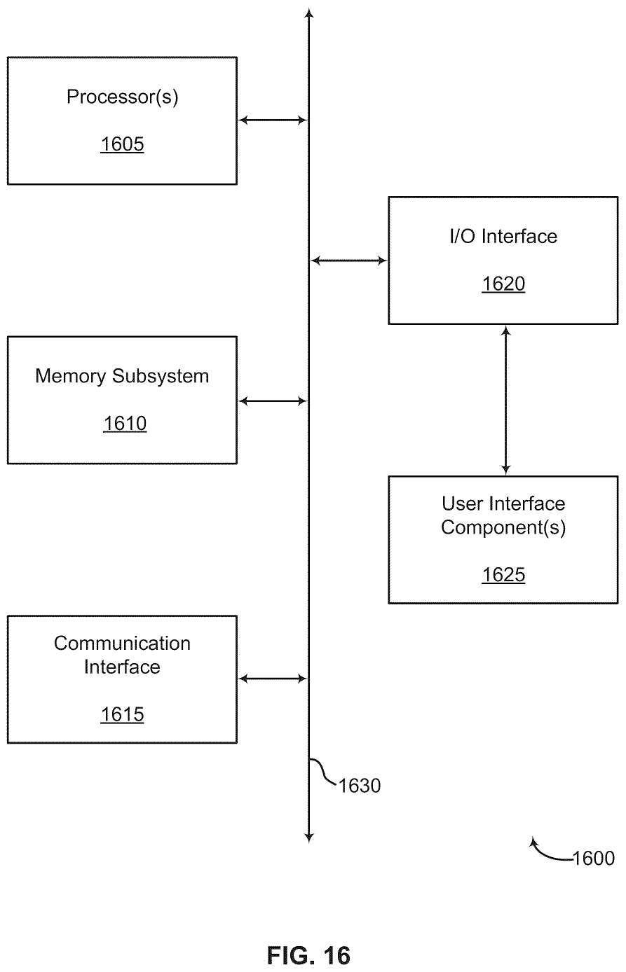

According to some aspects, video processing apparatus 115 includes a computer-implemented network. In some embodiments, the computer-implemented network includes a video generation model (such as the video generation model described with reference to at least FIGS. 4-9). In some embodiments, video processing apparatus 115 also includes one or more processors, a memory subsystem, a communication interface, an I/O interface, one or more user interface components, and a bus as described with reference to FIG. 16. Additionally, in some embodiments, video processing apparatus 115 communicates with user device 110 and database 125 via cloud 120.

In some cases, video processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, video processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to video processing apparatus 115 and communicates with video processing apparatus 115 via cloud 120. According to some aspects, database 125 is included in video processing apparatus 115.

FIG. 2 shows an example of a method 200 for video generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

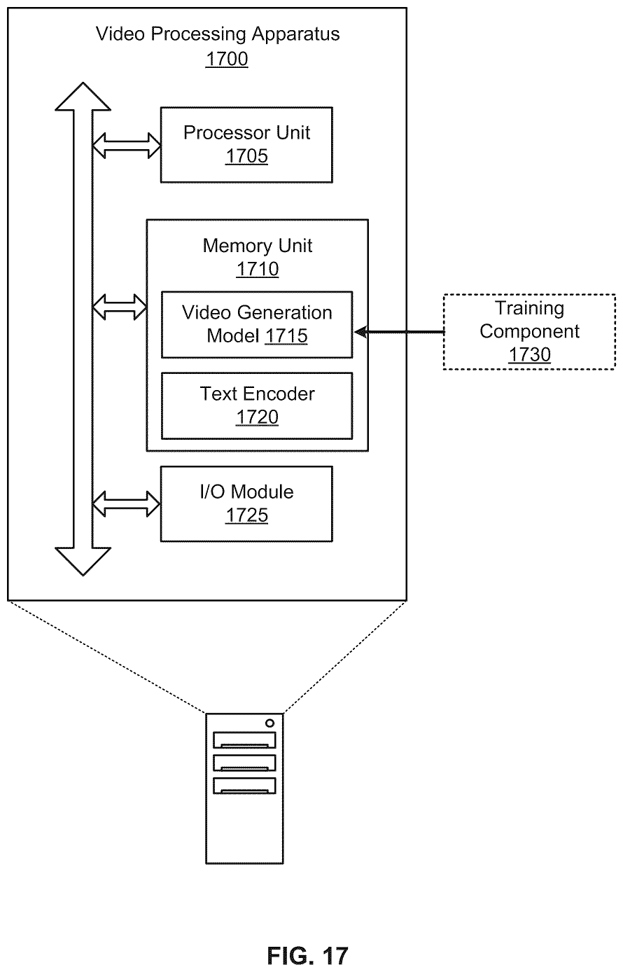

According to an embodiment of the present disclosure, a video processing apparatus (such as the video processing apparatus described with reference to FIGS. 3 and 17) provides a video generation model (such as the video generation model described with reference to FIGS. 4-9 and 17) that accurately generates a synthetic video depicting an element described in an input query or an action performed by the element described in the input query.

At operation 205, the system provides a query including text. In some cases, the operations of this step refer to, or may be performed by, a user as described with reference to FIG. 1.

In some cases, the text query describes an object based on which the user wants to generate a video. Additionally or alternatively, the text prompt provides an action based on which the user wants to generate a synthetic video. For example, the user provides a text prompt instructing the video processing apparatus to generate a synthetic video that accurately aligns with the text prompt. As shown in FIG. 2, the user provides a text prompt such as “a dog running on a street” to the video processing apparatus via a user interface of a user device (such as a user interface of user device 110 described with reference to FIG. 1).

At operation 210, the system generates a video based on the query. In some cases, the operations of this step refer to, or may be performed by, a video processing apparatus as described with reference to FIGS. 1 and 3.

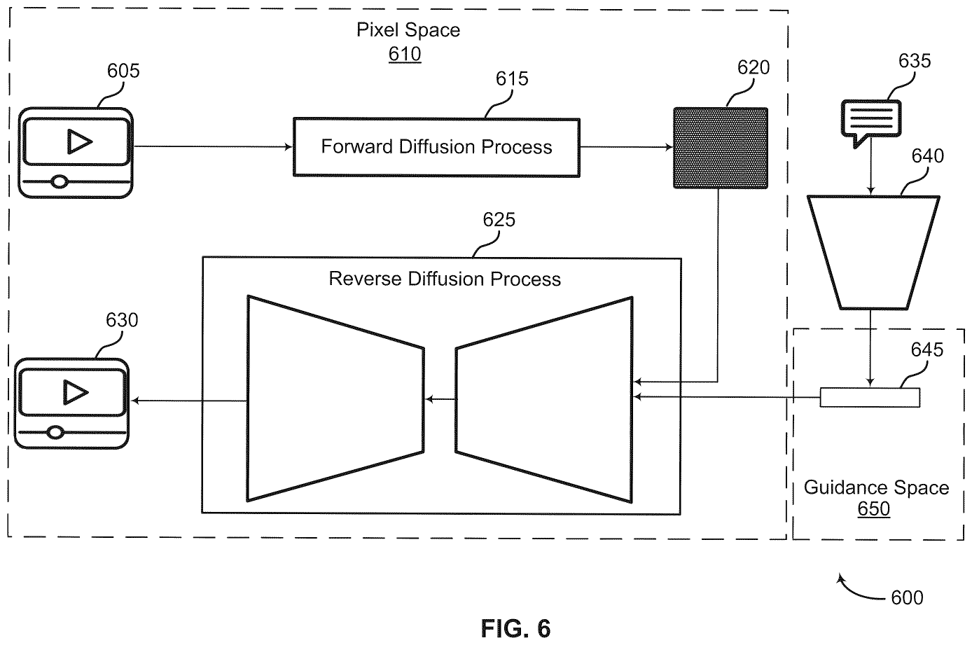

In some cases, the video processing apparatus includes a video generation model comprising a diffusion model (such as the diffusion model described with reference to FIGS. 6-9) that generates a synthetic video. In some cases, the video generation model generates the synthetic video comprising the object described in the text prompt. In some cases, the video generation model generates the synthetic video comprising the action described in the text prompt. As shown in FIG. 2, the video processing apparatus generates a synthetic video depicting “a dog running on a street” as provided by the user at operation 205.

In some cases, a video generation model of the present disclosure is based on the diffusion network. In some cases, the video generation model is configured to perform a partition of an input video sequence (e.g., input noise) to generate one or more non-overlapping temporal videos. In some cases, the video generation model comprising the diffusion network performs the self-attention windowed mechanism on each of the one or more non-overlapping temporal videos. In some cases, the video generation model is able to capture fine-grained temporal dynamics for each of the one or more non-overlapping temporal videos using the self-attention windowed mechanism.

At operation 215, the system provides the generated video to the user. In some cases, the operations of this step refer to, or may be performed by, a video processing apparatus as described with reference to FIGS. 1 and 3. The generated video is provided to the user via a user interface of the user device (such as user device 110 as described in FIG. 1). Further details regarding the generation of the video are provided with reference to at least FIGS. 4-10.

FIG. 3 shows an example of a video generation process 300 according to aspects of the present disclosure. In one aspect, video generation process 300 includes input prompt 305, video processing apparatus 310, and synthetic video 315.

In some examples, input prompt 305 describes an element. In some examples, as shown in FIG. 3, input prompt 305 describes an action performed by an element. In some examples, the user provides input prompt 305 to video processing apparatus 310 via a user interface of the video processing apparatus 310. Input prompt 305 is an example of, or includes aspects of, the corresponding element described with reference to FIGS. 1-2.

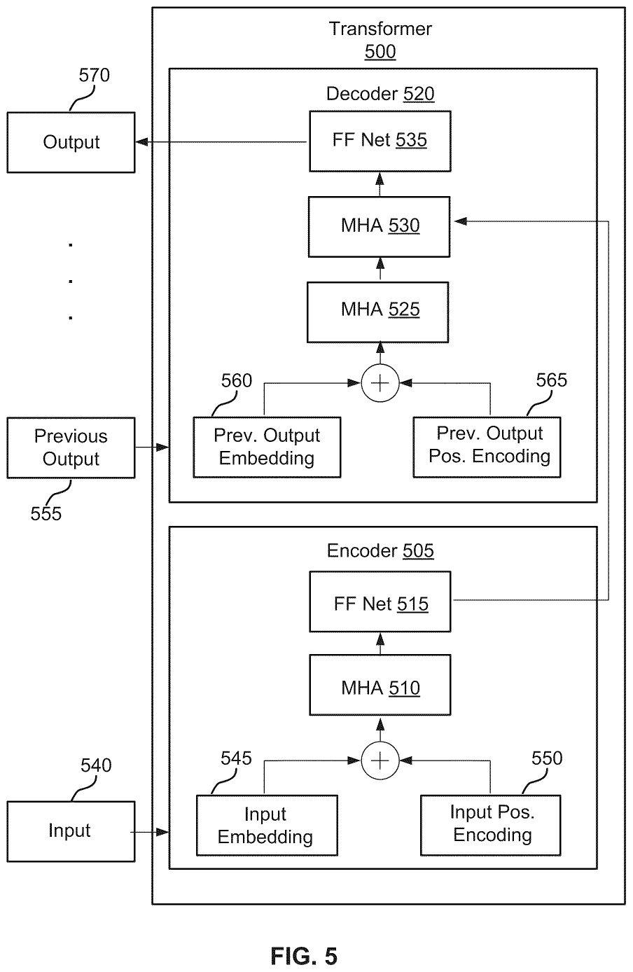

The video processing apparatus 310 (such as the video processing apparatus described with reference to at least FIGS. 1-2 and 17) of the present disclosure receives input prompt 305 from the user. In some cases, the video processing apparatus 310 comprises a video generation model including a video based diffusion network (such as the diffusion network described with reference to FIGS. 6-9) and a transformer model (such as the transformer model described with reference to FIG. 5) that generate a synthetic video based on a windowed self-attention method.

In some cases, the windowed self-attention mechanism is used for a video based diffusion network. According to an embodiment, the video generation model is configured to perform a global update and a local update. For instance, the video generation model updates a register token, an image token, a video token, and a text token based on an input prompt and a set of video frames from a video.

In some cases, the video generation model is configured to perform a partition of an input video sequence to generate one or more non-overlapping temporal videos. In some cases, the video generation model comprising the diffusion network is configured to perform the windowed self-attention mechanism on each of the one or more non-overlapping temporal videos.

In some cases, the video generation model is used to learn a global token and a global context. For example, the video generation model learns the global token from a key frame associated with each of the one or more non-overlapping temporal videos. By learning the global tokens and context from the key frames, the video processing apparatus 310 is able to efficiently propagate global context for video generation. Video processing apparatus 310 is an example of, or includes aspects of, the corresponding element described with reference to FIG. 1. Video 315 is an example of, or includes aspects of, the corresponding element described with reference to FIGS. 1-2 and 4.

FIG. 4 shows an example of a video generation process 400 according to aspects of the present disclosure. In one aspect, video generation process 400 includes global token 405, plurality of tokens 410, text token 415, key frame 420, frame token 425, local window 430, and subsequent window 435.

Embodiments of the present disclosure include a video generation model configured to perform a windowed self-attention operation. In some cases, the attention operation includes a process of simultaneously updating a global token and frame tokens. In some cases, the attention operation includes a process of updating global token (such as to generate updated global token 405-b). Additionally, in some cases, the attention operation includes a process of generating an updated frame token 425-b and an updated key frame 420-b.

For example, the global token 405 (i.e., each of global token 405-a and updated global token 405-b) consists of a learnable register token, an image token, a video token, a text token, or a combination thereof. In some cases, as shown with reference to FIG. 4 in Step 1, updated global token 405-b is generated by performing an attention process based on each token among the text tokens 415-a and plurality of tokens 410. For example, the plurality of tokens 410 include a plurality of key frames (such as key frame 420) and the corresponding or subsequent set of frame tokens (such as frame tokens 425). In some examples, global token 405-b is generated by updating global token 405-a based on performing windowed self-attention operation on global token 405-a, key frame 420, frame tokens 425, and text tokens 415-a (as indicated in arrows that attend to each token).

Additionally, the text token 415-a is updated to generate updated text token 415-b by performing windowed self-attention operation based on the global token 405-a and the text token 415-a. In some examples, text token 415-a is generated based on an input prompt (such as the input prompt described with reference to FIGS. 1-3).

In some cases, the video generation model updates the frame tokens with a local window. For example, the video generation model performs the update by performing an attention process based on tokens within the current window. As shown in Step 2 of FIG. 4, the video generation model performs a local update by performing an attention process based on each frame token within the current window, such as local window 430. In some cases, each of the frame tokens within the current window attend to the global tokens. In some cases, each frame token comprises unique information related to a frame block.

In some cases, the key frame 420-a is updated to generate updated key frame 420-b by performing an attention process based on global token 405, text token 415, and frame tokens 425-a within the local window 430. Additionally, in some cases, the frame tokens are updated by performing an attention process based on key frame 420-a within the current window and subsequent key frames. For example, the subsequent key frames refer to key frames that are part of subsequent windows, respectively.

As shown in FIG. 4, the frame token (such as each of frame token 425-a of the local window 430) attends to the subsequent key frames of subsequent local windows. Step 2 in FIG. 4 shows arrows to depict attention to each key frame token (such as key frame 420) corresponding to a local window 430. Accordingly, updated frame token 425-b is generated by performing windowed self-attention based on global token 405, text token 415, each token within the current local window 430, a previous key frame, and subsequent key frames in subsequent windows (such as subsequent window 435).

As shown in FIG. 4, each local window comprises a key frame and a set of 4 frame tokens, such as local window 430 comprises key frame 420 and frame tokens 425. However, FIG. 4 is merely a representation. Embodiments are not limited thereto, and in some examples, the window may include approximately 2000 tokens. Accordingly, the frame token refers to a plurality of unique tokens, e.g., as shown in FIG. 4, each token (each bar depicting the frame token 425 in FIG. 4) may represent approximately 500 unique tokens. According to an exemplary embodiment, the global token, such as global token 405 may refer to a vector of dimensions 512×2048. In some examples, as shown in FIG. 4, the text token may refer to a vector of dimensions 3×2048.

An embodiment of the present disclosure is configured to vary the window size at different attention layers of the diffusion network. In some cases, the video generation model uses a first window size (such as window size of local window 430) at a first attention layer of the diffusion network. In some cases, the video generation model uses a second window size, different from the first window size, at a second attention layer of the diffusion network different from the first attention layer,

An embodiment of the present disclosure is configured to perform a shifting window operation. In some cases, the video generation model shifts a position of the window across the attention layer, such as from local window 430 associated with frame tokens 425-a to a subsequent window 435 associated with subsequent tokens. For example, the video generation model performs the position shifting to enable propagation of global information across the attention layers of the diffusion network. In some examples, by performing a position shift of the windows, embodiments of the present disclosure are able to increase an efficiency of global information propagation.

FIG. 5 shows an example of a transformer network 500 according to aspects of the present disclosure. The example shown includes transformer 500, encoder 505, decoder 520, input 540, input embedding 545, input positional encoding 550, previous output 555, previous output embedding 560, previous output positional encoding 565, and output 570. According to some aspects, encoder 505 is implemented as a video encoder of a multi-modal encoder. According to some aspects, encoder 505 is implemented as a text encoder of conditional text encoder. According to some aspects, transformer 500 is implemented in the video generation model (such as the video generation model described with reference to FIGS. 4, 6-9, and 17).

In some cases, encoder 505 includes multi-head self-attention sublayer 510 and feed-forward network sublayer 515. In some cases, decoder 520 includes first multi-head self-attention sublayer 525, second multi-head self-attention sublayer 530, and feed-forward network sublayer 535.

In some cases, encoder 505 is configured to map input 540 (for example, a text prompt) to a sequence of continuous representations that are fed into decoder 520. In some cases, decoder 520 generates output 570 (e.g., a prediction of an output sequence of words or tokens) based on the output of encoder 505 and previous output 555 (e.g., a previously predicted output sequence), which allows for the use of autoregression.

For example, in some cases, encoder 505 parses input 540 into tokens and vectorizes the parsed tokens to obtain input embedding 545, and adds input positional encoding 550 (e.g., positional encoding vectors for input 540 of a same dimension as input embedding 545) to input embedding 545. In some cases, input positional encoding 550 includes information about relative positions of words or tokens in input 540.

In some cases, encoder 505 comprises one or more encoding layers that generate contextualized token representations, where each representation corresponds to a token that combines information from other input tokens via self-attention mechanism. In some cases, each encoding layer of encoder 505 comprises a multi-head self-attention sublayer (e.g., multi-head self-attention sublayer 510). In some cases, the multi-head self-attention sublayer implements a multi-head self-attention mechanism that receives different linearly projected versions of queries, keys, and values to produce outputs in parallel. In some cases, each encoding layer of encoder 505 also includes a fully connected feed-forward network sublayer (e.g., feed-forward network sublayer 515) comprising two linear transformations surrounding a Rectified Linear Unit (ReLU) activation:

$$F F N ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation each word or token in input 540.

In some cases, each sublayer of encoder 505 is followed by a normalization layer that normalizes a sum computed between a sublayer input x and an output sublayer(x) generated by the sublayer:

$$l ayernor m ( x + s ublaye r ( x ) ) \qquad ( 2 )$$

In some cases, encoder 505 is bidirectional because encoder 505 attends to each word or token in input 540 regardless of a position of the word or token in input 540.

According to some aspects, encoder 505 functions as a text encoder of the conditional text encoder. In an example, conditional text encoder splits an input text into fixed-size segments, generates a linear embedding of each of the segments, adds position embeddings to each of the linear embeddings, and provides the resulting sequence of vectors as input 540 to encoder 505.

In some cases, decoder 520 comprises one or more decoding layers (e.g., six decoding layers). In some cases, each decoding layer comprises three sublayers including a first multi-head self-attention sublayer (e.g., first multi-head self-attention sublayer 525), a second multi-head self-attention sublayer (e.g., second multi-head self-attention sublayer 530), and a feed-forward network sublayer (e.g., feed-forward network sublayer 535). In some cases, each sublayer of decoder 520 is followed by a normalization layer that normalizes a sum computed between a sublayer input x and an output sublayer(x) generated by the sublayer.

In some cases, decoder 520 generates previous output embedding 560 of previous output 555 and adds previous output positional encoding 565 (e.g., position information for words or tokens in previous output 555) to previous output embedding 560. In some cases, each first multi-head self-attention sublayer receives the combination of previous output embedding 560 and previous output positional encoding 565 and applies a multi-head self-attention mechanism to the combination. In some cases, for each word in an input sequence, each first multi-head self-attention sublayer of decoder 520 attends only to words preceding the word in the sequence, and so a prediction of transformer 500 for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 505 by receiving a query Q from a previous sublayer of decoder 520 and a key K and a value V from the output of encoder 505, allowing decoder 520 to attend to each word in the input 540.

In some cases, each feed-forward network sublayer implements a fully connected feed-forward network similar to feed-forward network sublayer 515. In some cases, the feed-forward network sublayers are followed by a linear transformation and a softmax to generate a prediction of output 570.

FIG. 6 shows an example of a guided diffusion model 600 according to aspects of the present disclosure. In some examples, guided diffusion model 600 describes the operation and architecture of the video generation model 1715 described with reference to FIG. 17. The guided latent diffusion model 600 depicted in FIG. 6 is an example of, or includes aspects of, a video generation model as described herein.

Diffusion models are a class of generative neural networks which can be trained to generate new data with features similar to features found in training data. In particular, diffusion models can be used to generate novel media items such as images, audio files, videos, three-dimensional (3D) models or other digital media items. Diffusion models can be used for various media processing tasks including image super-resolution, generation of media items with perceptual metrics, conditional generation (e.g., generation based on text guidance), image inpainting, and media manipulation.

Diffusion models work by iteratively adding noise to the data during a forward process and then learning to recover the data by denoising the data during a reverse process. For example, during training, guided latent diffusion model 600 may take an original media item 605 in a pixel space 610 as input and apply forward diffusion process 615 to gradually add noise to the original media item 605 to obtain noisy media item 620 at various noise levels.

Next, a reverse diffusion process 625 (e.g., a U-Net) gradually removes the noise from the noisy media item 620 at the various noise levels to obtain an output media item 630. In some cases, an output media item 630 is created from each of the various noise levels. The output media item 630 can be compared to the original media item 605 to train the reverse diffusion process 625.

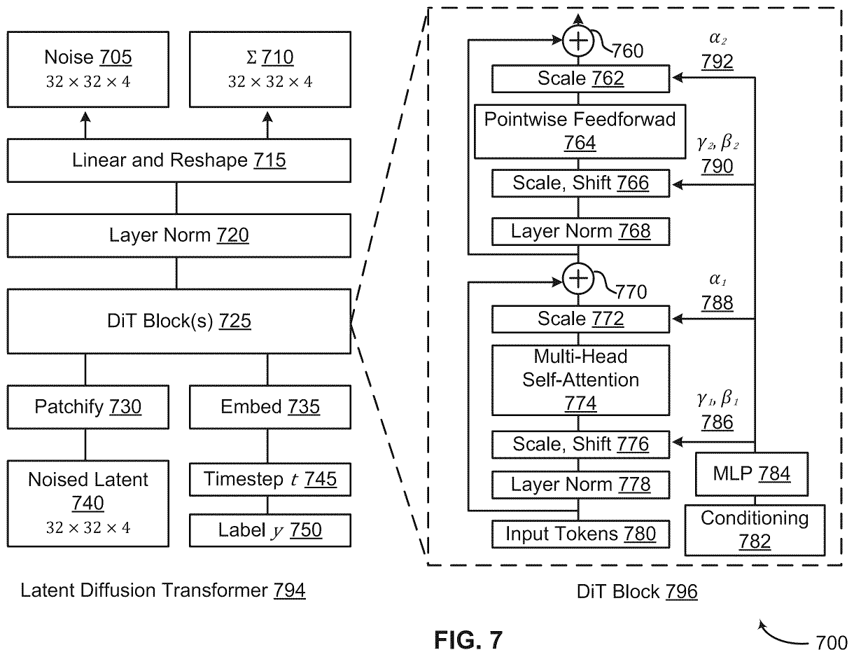

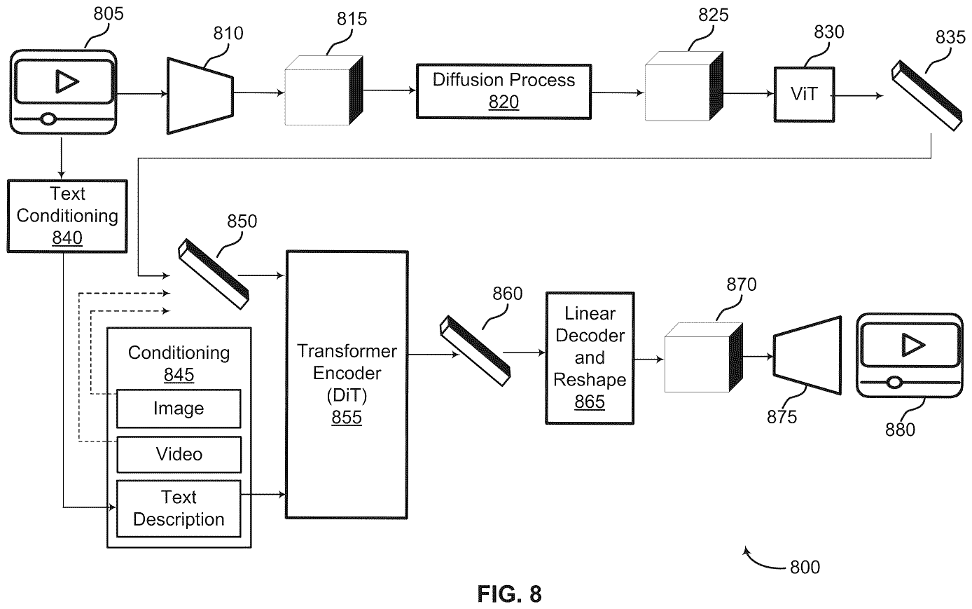

The reverse diffusion process 625 can also be guided based on a text prompt 635, or another guidance prompt, such as an image, a layout, a segmentation map, etc. The text prompt 635 can be encoded using a text encoder 665 (e.g., a multimodal encoder) to obtain guidance features 645 in guidance space 650. The guidance features 645 can be combined with the noisy media item 620 at one or more layers of the reverse diffusion process 625 to ensure that the output media item 630 includes content described by the text prompt 635. For example, guidance features 645 can be combined with the noisy features using a cross-attention block within the reverse diffusion process 625. For instance, reverse diffusion process 625 can be a diffusion transformer network (such as diffusion transformer network described with reference to FIG. 7) or a U-Net (such as U-Net 800 described with reference to FIG. 8).

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during media generation. Diffusion models may also be characterized by whether the noise is added to the media item itself, or to media features generated by an encoder (i.e., latent diffusion). In a pixel diffusion model, noise is added and removed in pixel space. In a latent diffusion model, the noise is added (and removed) in a latent space of media features rather than in pixel space. Thus, a latent diffusion model generates media features using reverse diffusion, and these media features can be decoded to obtain a synthetic media item. DDIM is an example of, or includes aspects of, the corresponding element described with reference to FIGS. 2, 5, 7-9, and 11-17.

FIG. 7 shows an example of a diffusion transformer (DiT) architecture according to aspects of the present disclosure. The example shown includes noised latent 700, patchify operation 705, timestep embedding 710, DiT block(s), layer normalization 720, linear and reshape layers 725, predicted noise 730, input tokens 735, conditioning tokens 740, self-attention 745, cross-attention 750, and feed-forward network 755.

Patchify operation 705 is an example of, or includes aspects of, the corresponding element described with reference to FIG. 4. Input tokens 735 is an example of, or includes aspects of, the corresponding element described with reference to FIGS. 4 and 10.

The DiT architecture processes noised latent 700, which may be a noised version of an input image encoded in a latent space. Patchify operation 705 divides the noised latent into a sequence of patches that are processed as tokens. The tokens are vector representations of each patch of the image in latent space and are adjusted through attention processes. Each of the tokens also receives timestep embedding 710, which encodes the current denoising timestep, and a positional embedding which encodes each token's spatial position in the image. The tokens and timestep information are processed through N DiT block(s) 715, where N refers to the number of DiT blocks.

Each DiT block 715 includes multiple processing stages. Initially, a pruning operation is performed where a router model determines which tokens to process or skip based on learned, layer and timestep-adaptive compression ratios. The remaining tokens are processed as input tokens 735, which interact with conditioning tokens 740 through multiple attention mechanisms. Self-attention 745 allows input tokens to attend to each other, while cross-attention 750 enables input tokens to attend to the conditioning tokens 740. The outputs are then processed through feed-forward network 755. This process repeats for each DiT block in the sequence.

After processing through all DiT blocks, the outputs undergo layer normalization 720 followed by linear and reshape layers 725. The final output is predicted noise 730, which represents the model's prediction of the noise that was added to create the initial noised latent 700. The predicted noise 730 is removed noised latent 700 at each diffusion timestep. At the end of the denoising schedule, the latent sample is decoded to generate the synthetic image in pixel space.

FIG. 8 shows an example of a diffusion transformer network for a video 800 according to aspects of the present disclosure. In some examples, the diffusion transformer network 800 comprises variational autoencoder 810, diffusion process 820, vision transformer 830, transformer encoder (DiT) 850, linear decoder and reshape 860, and decoder 870. In some aspects, the diffusion transformer network 800 generates visual patches 815, diffused visual patches 825, latent vector 835, denoised latent code 855, denoised patches 865, media item 875.

As shown, a training video 805 comprising a plurality of frames (e.g., 1920×1080 resolution) is processed by a visual encoder 810 (such as a variational autoencoder (VAE) encoder module). The visual encoder 810 generates a set of latent representations 815 referred to herein as visual patches, which correspond to compressed representations of the visual content of the input video 805.

These visual patches 815 are subjected to a diffusion process 820 (such as the diffusion process described with reference to FIGS. 6-7 and 9), which incrementally corrupts the patches by adding noise according to a predetermined noise schedule. The diffused visual patches are then processed by a vision transformer (ViT) module 830 configured to apply both patch-based and positional encoding, thereby producing a latent representation 835 that captures spatial and temporal dependencies across video frames.

In some cases, the diffusion transformer network 800 takes conditioning inputs 845, including textual descriptions, images, and/or video as input. The inputs (latent representation 835, conditioning input 845) may be processed using a language and vision encoder to generate a conditional latent 850. The conditional latent 850 may represent features aligned with the user's intent or semantic constraints.

A transformer encoder 855, such as a diffusion transformer (DiT, such as described with reference to FIG. 7), receives the latent representation and the conditional latent 850, and processes the combined information across a series of transformer layers. The output 860 of the transformer encoder 855 is decoded via a linear decoder followed by a reshaping operation 865 to generate a sequence of latent representations 870 corresponding to predicted visual content.

In some cases, a VAE decoder 875 reconstructs the video 880 from the decoded latent representations 870. The resulting output video 880 may be generated in response to a text or visual prompt or may reconstruct the original training video content.

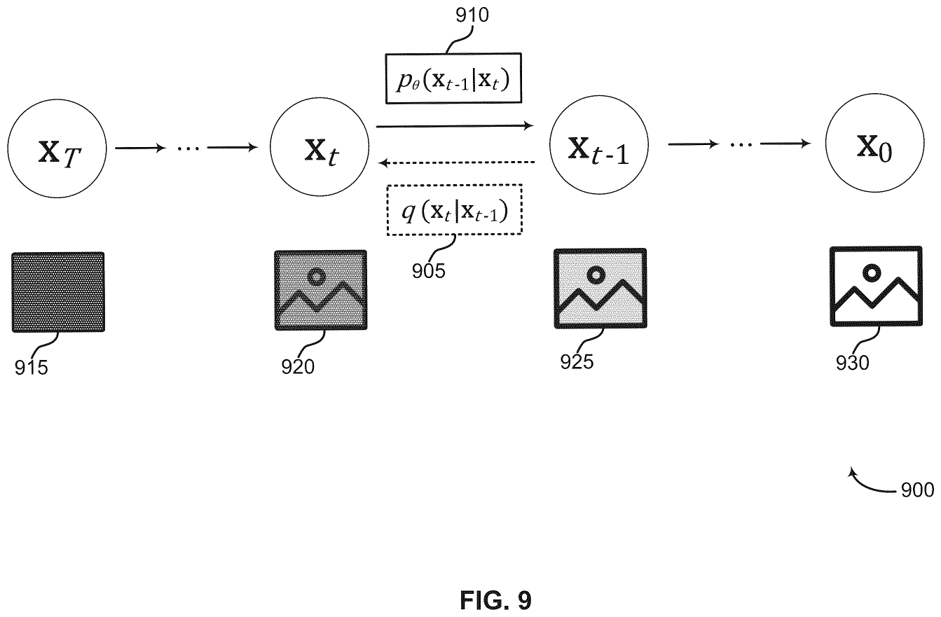

FIG. 9 shows a diffusion process 900 according to aspects of the present disclosure. In some examples, diffusion process 900 describes an operation of the video generation model 1715 described with reference to FIG. 17, such as the reverse diffusion process 625 of guided diffusion model 600 described with reference to FIG. 6.

As described above with reference to FIG. 6, using a diffusion model can involve both a forward diffusion process 905 for adding noise to a media item (or features in a latent space) and a reverse diffusion process 910 for denoising the media item (or features) to obtain a denoised media item. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate media items with successively greater noise, and a neural network is trained to perform the reverse diffusion process 910 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 910, the model begins with noisy data x_{T}, such as a noisy media item 915 and denoises the data to obtain the p(xₜ₋₁|xₜ). At each step t−1, the reverse diffusion process 910 takes xₜ, such as first intermediate media item 920, and t as input. Here, t represents a step in the sequence of transitions associated with different noise levels, The reverse diffusion process 910 outputs xₜ₋₁, such as second intermediate media item 925 iteratively until x_{T} reverts back to x₀, the original media item 930. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 3 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 4 )$$

where p(x+)=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and \tilde{x} represents the generated item with high quality.

Accordingly, an apparatus for video processing is described. One or more aspects of the apparatus include obtaining an input prompt describing a scene; generating, using a video generation model, a global token based on the input prompt by performing an attention process based on a plurality of frame tokens; generating, using the video generation model, a frame token by performing an attention process based on the global token and a subset of the plurality of frame tokens in a local window; and generating, using the video generation model, a synthetic video based on the frame token, wherein the synthetic video depicts the scene and includes an image frame corresponding to the frame token. In some aspects, the video generation model comprises a diffusion network.

Some examples of the apparatus and system further include a text encoder configured to generate a text token based on the input prompt, wherein the global token and the frame token are generated by performing an attention process based on the text token. Some examples of the apparatus and system further include generating the frame token comprises performing an attention process based on a plurality of key frames corresponding to a plurality of frame blocks, respectively, wherein each of the plurality of frame blocks comprises a unique subset of the plurality of frame tokens.

Some examples of the apparatus and system further include generating the frame token comprises initializing a plurality of noisy frame tokens; and denoising the plurality of noisy frame tokens based on the global token to obtain the plurality of frame tokens. Some examples of the apparatus and system further include generating the synthetic video comprises generating a plurality of image frames corresponding to the plurality of frame tokens.

### Video Generation Process

The present disclosure describes systems and methods for video generation. Embodiments of the present disclosure are configured to perform a windowed self-attention mechanism in a video generation model. In some cases, the video generation model of the present disclosure is based on a diffusion network. In some cases, the video generation model is configured to perform a partition of an input video sequence to generate one or more non-overlapping temporal videos.

Embodiments of the present disclosure are configured to perform a non-overlapping windowed self-attention mechanism. In some cases, the video generation model modifies a size of the window. For example, the video generation model reduces complexity associated with the window size based on a linear variation. In some examples, the video generation model performs partitioning of the input video sequence based on a variable window size. By varying the window sizes at the different attention layers, embodiments of the present disclosure are able to optimize efficiency and performance of video generation.

An embodiment of the present disclosure is configured to perform video generation. In some cases, the video generation model is used to learn a global token and a global context. For example, the video generation model learns the global token from a key frame associated with each of the one or more non-overlapping temporal videos. For example, the video generation model learns the global context from the key frame associated with each of the one or more non-overlapping temporal videos. By using the video generation model to learn the global tokens and context from the key frames, embodiments of the present disclosure are able to efficiently propagate global context for video generation.

In some cases, the video generation model is used to implement context from a nearby key frame. For example, the nearby key frame refers to the key frame in proximity of the current window. In some cases, the video generation model is used to implement a context from a shifting window across the attention layers. For example, the windows are shifted across the attention layers of the video generation model comprising the diffusion network. By incorporating the context from the nearby key frames and the shifting windows, embodiments of the present disclosure are able to ensure consistency and efficient propagation of global context across the diffusion network architecture of the video generation model.

FIG. 10 shows an example of a method 1000 for video processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains an input prompt. In some cases, the operations of this step refer to, or may be performed by, a user interface as described with reference to FIG. 1.

For example, in some cases, the user interface of the video processing apparatus (such as video processing apparatus 1700 described with reference to FIG. 17) receives an input prompt from a user. In some examples, the input prompt comprises a text prompt that describes an object that the user wants to depict in the generated asset (e.g., video). Additionally or alternatively, for example, the input prompt comprises a text prompt that describes an action performed by an element that the user wants to depict in the generated asset (e.g., video). In some examples, the video processing apparatus receives the input prompt from a database or any other data source.

At operation 1010, the system generates a global token based on the input prompt and a global set of tokens corresponding to a set of video frames. In some cases, the operations of this step refer to, or may be performed by, a video generation model as described with reference to FIGS. 4-9 and 17.

The present disclosure describes systems and methods for video generation. Embodiments of the present disclosure include a video generation model configured to perform a windowed self-attention operation. In some cases, the attention operation includes a process of updating global tokens (such as global token 405 described with reference to FIG. 4) and a process of updating frame tokens. For example, the global tokens consist of a learnable register token, an image token, a video token, and a text token.

In some cases, the global token is updated by performing an attention process based on each token to generate an updated global token. As shown in Step 1 of FIG. 4, global token 405-a is updated to generate updated global token 405-b by performing an attention process based on each text token among the text tokens (such as the text tokens 415), key frame (such as key frame 420), and frame tokens (such as frame tokens 425), as indicated in arrows.

At operation 1015, the system generates a frame token based on the global token and a local subset of tokens from the global set of tokens, where the local subset of tokens corresponds to a local window including a subset of video frames from the set of video frames, and where the frame token corresponds to a frame within the subset of video frames. In some cases, the operations of this step refer to, or may be performed by, a video generation model as described with reference to FIGS. 4-9 and 17.

In some cases, the windowed self-attention operation includes a process of updating key frames and a process of updating frame tokens, in addition to the process of updating global tokens described in operation 1010. In some cases, the video generation model updates the tokens with a local window (such as local window 430 described with reference to Step 2 of FIG. 4). For example, the video generation model performs the update by performing an attention process based on each token within the local window 430. In some cases, the frame tokens attend to the global tokens.

Additionally, in some cases, the frame tokens attend to the nearby key frames. For example, the frame tokens attend to previous key frames and the subsequent key frames of the subsequent local subset of tokens. As shown with reference to Step 2 of FIG. 4, each frame token in the local subset of tokens (i.e., local window 430) attends to previous key frames and to subsequent key frames associated with a subsequent local subsets of tokens, such as subsequent key frame associated with subsequent local window 435.

At operation 1020, the system generates a video based on the frame token, where the video includes an image corresponding to each of the set of video frames. In some cases, the operations of this step refer to, or may be performed by, a video generation model as described with reference to FIGS. 4-9 and 17. In some embodiments, the user interface provides the video to the user via the user interface.

An embodiment of the present disclosure is configured to vary the window size. In some cases, the video generation model uses a first window size at a first attention layer of the diffusion network. In some cases, the video generation model uses a second window size, different from the first window size, at a second attention layer of the diffusion network different from the first attention layer.

An embodiment of the present disclosure is configured to perform a shifting window operation. In some cases, the video generation model shifts a position of the window across the attention layer. For example, the video generation model performs the position shifting to enable propagation of global information across the attention layers of the diffusion network. In some examples, by performing a position shift of the windows, embodiments of the present disclosure are able to increase an efficiency of global information propagation.

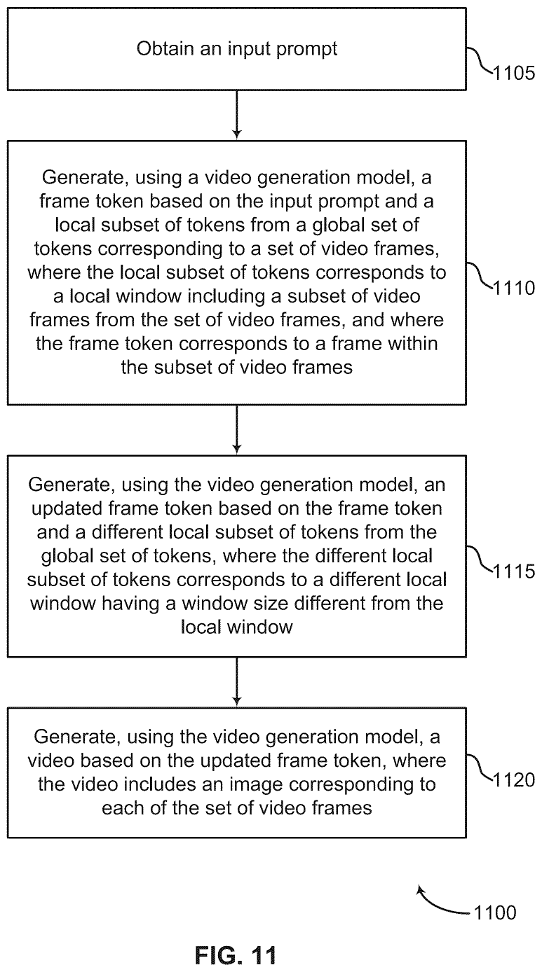

FIG. 11 shows an example of a method 1100 for video processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1105, the system obtains an input prompt. In some cases, the operations of this step refer to, or may be performed by, a video processing apparatus as described with reference to FIG. 17.

For example, in some cases, the user interface of the video processing apparatus (such as video processing apparatus 1700 described with reference to FIG. 17) receives an input prompt from a user. In some examples, the input prompt comprises a text prompt that describes an object that the user wants to depict in the generated asset (e.g., video). Additionally or alternatively, for example, the input prompt comprises a text prompt that describes an action performed by an element that the user wants to depict in the generated asset (e.g., video). In some examples, the video processing apparatus receives the input prompt from a database or any other data source.

At operation 1110, the system generates a frame token based on the input prompt and a local subset of tokens from a global set of tokens corresponding to a set of video frames, where the local subset of tokens corresponds to a local window including a subset of video frames from the set of video frames, and where the frame token corresponds to a frame within the subset of video frames. In some cases, the operations of this step refer to, or may be performed by, a video generation model as described with reference to FIG. 17.

At operation 1115, the system generates an updated frame token based on the frame token and a different local subset of tokens from the global set of tokens, where the different local subset of tokens corresponds to a different local window having a window size different from the local window. In some cases, the operations of this step refer to, or may be performed by, a video generation model as described with reference to FIG. 17.

In some cases, the attention operation includes a process of updating frame tokens while updating the global token and the text tokens. In some cases, the video generation model updates the frame tokens within a local window (such as updates frame tokens 425-a in local window 430 to generate updated frame tokens 425-b, as described with reference to Step 2 of FIG. 4). For example, the video generation model performs the update by performing an attention process based on each frame token within the local window. In some cases, the frame tokens attend to the global token and the text token (such as global token 405 and text tokens 415, respectively, in Step 2 of FIG. 4).

Additionally, in some cases, the frame tokens attend to the nearby key frames. For example, the frame tokens attend to previous key frames and the subsequent key frames of the subsequent local windows. As shown with reference to Step 2 of FIG. 4, each frame token 425 in the local window 430 attends to previous key frames and to subsequent key frames associated with a subsequent local subsets of tokens, such as subsequent key frame associated with subsequent local window 435.

At operation 1120, the system generates a video based on the updated frame token, where the video includes an image corresponding to each of the set of video frames. In some cases, the operations of this step refer to, or may be performed by, a video generation model as described with reference to FIG. 17. In some embodiments, the user interface provides the video to the user via the user interface.

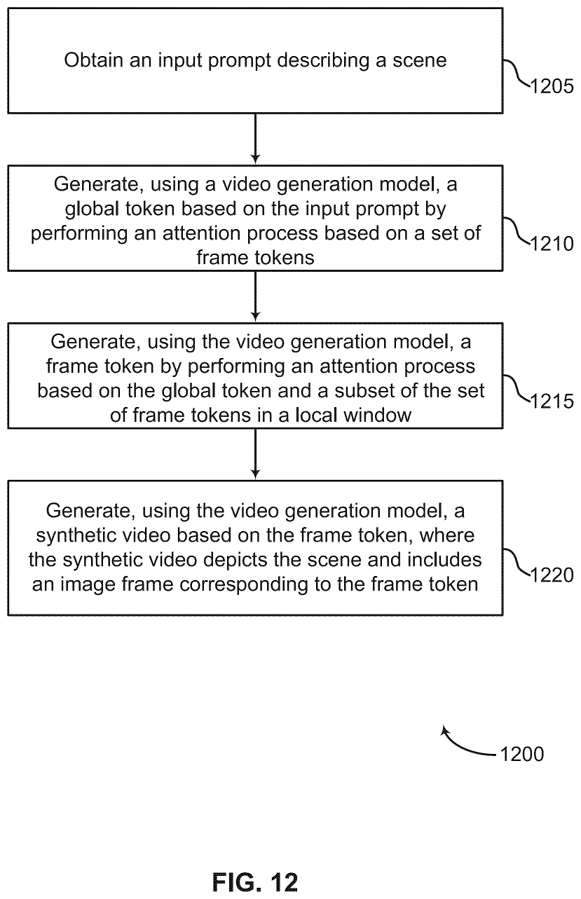

FIG. 12 shows an example of a method 1200 for video processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1205, the system obtains an input prompt describing a scene. In some cases, the operations of this step refer to, or may be performed by, a video processing apparatus as described with reference to FIG. 17.

For example, in some cases, the user interface of the video processing apparatus (such as video processing apparatus 1700 described with reference to FIG. 17) receives an input prompt from a user. In some examples, the input prompt comprises a text prompt that describes a scene based on which the user wants to generate an asset (e.g., a synthetic video). Additionally or alternatively, for example, the input prompt comprises a text prompt that describes an action performed by an element in the scene, that the user wants to depict in the synthetic video). In some examples, the video processing apparatus receives the input prompt from a database or any other data source.

At operation 1210, the system generates a global token based on the input prompt by performing an attention process based on a set of frame tokens. In some cases, the operations of this step refer to, or may be performed by, a video generation model as described with reference to FIG. 17.

An embodiment of the present disclosure includes a video generation model configured to perform a windowed self-attention operation. In some cases, the attention operation includes a process of updating global token (such as global token 405-a is updated to generate updated global token 405-b described with reference to Step 1 of FIG. 4). For example, the global token consists of a learnable register token, an image token, a video token, and a text token. In some cases, the global token is updated by performing self-attention based on each token among the plurality of tokens (such as global token 405-a, text token 415-a, and plurality of tokens 410 as indicated by arrows, as described with reference to Step 1 of FIG. 4). As shown in FIG. 4, the plurality of tokens 410 include key frame 420 and frame tokens 425.

At operation 1215, the system generates a frame token by performing an attention process based on the global token and a subset of the set of frame tokens in a local window. In some cases, the operations of this step refer to, or may be performed by, a video generation model as described with reference to FIG. 17.

In some cases, the video generation model generates the frame token based on the global token and frame tokens within the local window, where the frame token corresponds to a local window including a subset of video frames from the set of video frames, and where the frame token corresponds to a frame within the subset of video frames.

In some cases, the attention operation includes a process of updating frame tokens while updating the global token and the text tokens. In some cases, as described in FIG. 4, the video generation model updates the frame tokens within a local window (such as frame tokens 425-a in local window 430 are updated to generate updated frame tokens 425-b, as described with reference to Step 2 of FIG. 4). Additionally, for example, the video generation model updates the frame tokens 425-a by performing a windowed self-attention operation based on each frame token within the local window 430. In some cases, the frame tokens 425-a attend to the global token 405, text tokens 415, and key frame 420.

Additionally, in some cases, the frame tokens attend to the nearby key frames. For example, the frame tokens attend to previous key frames and subsequent key frames of the subsequent local subset of tokens. As shown with reference to Step 2 of FIG. 4, each frame token 425-a in the local window 430 attends (as shown with arrows) to previous key frames and to subsequent key frames associated with a subsequent local window, such as subsequent key frame associated with subsequent local window 435, to generate updated frame tokens 425-b.

At operation 1220, the system generates a synthetic video based on the frame token, where the synthetic video depicts the scene and includes an image frame corresponding to the frame token. In some cases, the operations of this step refer to, or may be performed by, a video generation model as described with reference to FIG. 17. In some embodiments, the user interface provides the video to the user via the user interface.

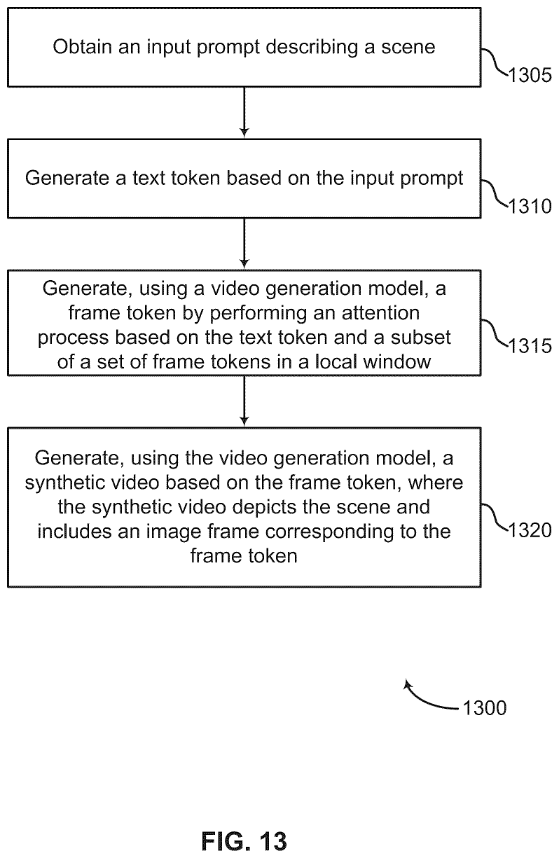

FIG. 13 shows an example of a method 1300 for video processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1305, the system obtains an input prompt describing a scene. In some cases, the operations of this step refer to, or may be performed by, a video processing apparatus as described with reference to FIG. 17.

For example, in some cases, the user interface of the video processing apparatus (such as video processing apparatus 1700 described with reference to FIG. 17) receives an input prompt from a user. In some examples, the input prompt comprises a text prompt that describes a scene based on which the user wants to generate an asset (e.g., a synthetic video). Additionally or alternatively, for example, the input prompt comprises a text prompt that describes an action performed by an element in the scene that the user wants to depict in the synthetic video. In some examples, the video processing apparatus receives the input prompt from a database or any other data source.

At operation 1310, the system generates a text token based on the input prompt. In some cases, the operations of this step refer to, or may be performed by, a text encoder as described with reference to FIG. 17.

According to an embodiment, a text encoder is configured to process an input prompt and generate a text token. For example, the input prompt refers to a text input comprising natural language phrases, captions, sentences, other structured or unstructured linguistic content, etc. In some examples, the text encoder may include one or more neural network architectures, such as transformer-based models, recurrent neural networks, or convolutional networks, which receive the input prompt and perform tokenization, embedding, and contextual encoding operations to generate a corresponding text token. For example, the generated text token may be represented as a high-dimensional vector capturing the semantic and syntactic properties of the input prompt.

At operation 1315, the system generates a frame token by performing an attention process based on the text token and a subset of a set of frame tokens in a local window. In some cases, the operations of this step refer to, or may be performed by, a video generation model as described with reference to FIG. 17.

In some cases, the video generation model generates a frame token based on the global token, the text tokens, and frame tokens, where the frame tokens correspond to a local window including a subset of video frames from the set of video frames, and where the frame token corresponds to a frame within the subset of video frames.

In some cases, a windowed self-attention operation updates the frame tokens, where the self-attention operation includes a process of updating frame tokens and simultaneously updating global token and text tokens. In some cases, the video generation model updates the frame tokens within a local window (such as updating frame tokens 425-a in local window 430 to generate updated frame tokens 425-b, as described with reference to Step 2 of FIG. 4). For example, the video generation model performs the update by performing an attention process based on each frame token within the local window. In some cases, the frame tokens attend to the global token, the text tokens, and each frame token within the local window.

Additionally, in some cases, the frame tokens attend to the nearby key frames. For example, the frame tokens attend to previous key frames and the subsequent key frames of the subsequent local subset of tokens. As shown with reference to Step 2 of FIG. 4, each frame token in the local subset of tokens 430 attends to previous key frames and to subsequent key frames associated with a subsequent local subsets of tokens, such as subsequent key frame associated with subsequent local window 435.

At operation 1320, the system generates a synthetic video based on the frame token, where the synthetic video depicts the scene and includes an image frame corresponding to the frame token. In some cases, the operations of this step refer to, or may be performed by, a video generation model as described with reference to FIG. 17. In some embodiments, the user interface provides the video to the user via the user interface.

An embodiment of the present disclosure is configured to vary the window size. In some cases, the video generation model uses a first window size at a first attention layer of the diffusion network. In some cases, the video generation model uses a second window size different from the first window size at a second attention layer different from the first attention layer of the diffusion network.

An embodiment of the present disclosure is configured to perform a shifting window operation. In some cases, the video generation model shifts a position of the window across the attention layer. For example, the video generation model performs the position shifting to enable propagation of global information across the attention layers of the diffusion network. In some examples, by performing a position shift of the windows, embodiments of the present disclosure are able to increase an efficiency of global information propagation.

Accordingly, a method for video processing is described. One or more aspects of the method include obtaining an input prompt describing a scene; generating, using a video generation model, a global token based on the input prompt by performing an attention process based on a plurality of frame tokens; generating, using the video generation model, a frame token by performing an attention process based on the global token and a subset of the plurality of frame tokens in a local window; and generating, using the video generation model, a synthetic video based on the frame token, wherein the synthetic video depicts the scene and includes an image frame corresponding to the frame token.

Some examples of the method, apparatus, and non-transitory computer readable medium further include generating a text token based on the input prompt, wherein the global token and the frame token are generated by performing an attention process based on the text token.

Some examples of the method, apparatus, and non-transitory computer readable medium further include generating the frame token comprises performing an attention process based on a plurality of key frames corresponding to a plurality of frame blocks, respectively, wherein each of the plurality of frame blocks comprises a unique subset of the plurality of frame tokens.

Some examples of the method, apparatus, and non-transitory computer readable medium further include generating the frame token comprising initializing a plurality of noisy frame tokens; and denoising the plurality of noisy frame tokens based on the global token to obtain the plurality of frame tokens.

Some examples of the method, apparatus, and non-transitory computer readable medium further include iteratively updating the global token based on the frame token. Some examples further include iteratively updating the frame token based on the global token.

Some examples of the method, apparatus, and non-transitory computer readable medium further include generating the synthetic video comprises generating a plurality of image frames corresponding to the plurality of frame tokens.

Some examples of the method, apparatus, and non-transitory computer readable medium further include identifying a diffusion timestep. Some examples further include determining whether to perform selective attention for the frame token based on the diffusion timestep, wherein the selective attention is based on the local window.

Additionally, a method for video processing is described. One or more aspects of the method include obtaining an input prompt describing a scene; generating a text token based on the input prompt; generating, using a video generation model, a frame token by performing an attention process based on the text token and a subset of a plurality of frame tokens in a local window; and generating, using the video generation model, a synthetic video based on the frame token, wherein the synthetic video depicts the scene and includes an image frame corresponding to the frame token.

Some examples of the method, apparatus, and non-transitory computer readable medium further include generating, using the video generation model, a global token based on the input prompt by performing an attention process based on the plurality of frame tokens, wherein the frame token is based on the global token.

Some examples of the method, apparatus, and non-transitory computer readable medium further include generating the frame token comprises initializing a plurality of noisy frame tokens; and denoising the plurality of noisy frame tokens based on the global token to obtain the plurality of frame tokens.

Some examples of the method, apparatus, and non-transitory computer readable medium further include iteratively updating the global token based on the frame token. Some examples further include iteratively updating the frame token based on the global token.

Some examples of the method, apparatus, and non-transitory computer readable medium further include generating the frame token comprises performing an attention process based on a plurality of key frames corresponding to a plurality of frame blocks, respectively, wherein each of the plurality of frame blocks comprises a unique subset of the plurality of frame tokens.

Some examples of the method, apparatus, and non-transitory computer readable medium further include generating the synthetic video comprises generating a plurality of image frames corresponding to the plurality of frame tokens.

Some examples of the method, apparatus, and non-transitory computer readable medium further include identifying a diffusion timestep. Some examples further include determining whether to perform selective attention for the frame token based on the diffusion timestep, wherein the selective attention is based on the local window.

### Training the System

An embodiment of the present disclosure is configured to perform video generation. In some cases, the video generation model is used to learn a global token and a global context. For example, the video generation model learns the global token from a key frame associated with each of one or more non-overlapping temporal videos.

In some cases, the global token refers to a compact representation of the input video sequence. For example, the global token captures long-range dependencies based on the input video sequence. Accordingly, by incorporating learnable global tokens from the key frame associated with each of the one or more non-overlapping temporal videos, embodiments of the present disclosure are able to capture long-range dependencies while reducing the computational cost associated with a self-attention mechanism.

An embodiment of the present disclosure is configured to implement a learnable register token during the video generation process. In some cases, the video generation model uses the learnable register tokens to propagate global context between the windows at each attention layer of the diffusion network. In some cases, the video generation model is configured to generate a video based on the diffusion network architecture.

FIG. 14 shows an example of a method of training a machine learning model according to aspects of the present disclosure. FIG. 14 is a flow diagram depicting an algorithm as a step-by-step procedure 1400 in an example implementation of operations performable for training a machine-learning model. In some embodiments, the procedure 1400 describes an operation of the training component 1730 described for configuring the video generation model 1715 as described with reference to FIG. 17. The procedure 1400 provides one or more examples of generating training data, use of the training data to train a machine-learning model, and use of the trained machine-learning model to perform a task.

To begin in this example, a machine-learning system collects training data (block 1402) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1406). Initialization of the machine-learning model includes selecting a model architecture (block 1408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1410). The loss function is utilized to measure a difference between an output of the machine-learning model (i.e., predictions) and target values (e.g., as expressed by the training data) to be used to train the machine-learning model. Additionally, an optimization algorithm is selected (1412) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1414) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1420), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1420), the procedure 1400 continues training of the machine-learning model using the training data (block 1418) in this example.

If the stopping criterion is met (“yes” from decision block 1420), the trained machine-learning model is then utilized to generate an output based on subsequent data (block 1422). The trained machine-learning model, for instance, is trained to perform a task as described above and therefore, once trained is configured to perform that task based on subsequent data received as an input and processed by the machine-learning model.

FIG. 15 shows an example of a method of training a diffusion model 1500 according to aspects of the present disclosure. In some embodiments, the method 1500 describes an operation of the training component 1730 described for configuring the video generation model 1715 as described with reference to FIG. 17. The method 1500 represents an example for training a reverse diffusion process as described above with reference to FIGS. 7-9. In some examples, these operations are performed by a system including a processor executing a set of codes to control functional elements of an apparatus, such as the guided diffusion model described in FIG. 6.

Additionally or alternatively, certain processes of method 1500 may be performed using special-purpose hardware. Generally, these operations are performed according to the methods and processes described in accordance with aspects of the present disclosure. In some cases, the operations described herein are composed of various substeps or are performed in conjunction with other operations.

Referring to FIG. 15, according to some aspects, a training component (such as the training component 1730 described with reference to FIG. 17) trains a diffusion model (such as the video generation model described with reference to FIGS. 6-9) to generate an output.

At operation 1505, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1510, the system adds noise to a training image (or an additional training image) using a forward diffusion process (such as the forward diffusion process described with reference to FIG. 7) in N stages. In some cases, the operations of this step refer to, or may be performed by, a training component as described with reference to FIG. 17.

At operation 1515, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 1520, the system compares predicted output (or features) at stage n−1 to an actual media item (or features), such as the output at stage n−1 or the original input. For example, given observed data x, the diffusion model may be trained to minimize the variational upper bound of the negative log-likelihood −log p_{θ}(x) of the training data.

At operation 1525, the system updates parameters of the model based on the comparison. For example, parameters of a U-Net may be updated using gradient descent. Time-dependent parameters of the Gaussian transitions can also be learned.

Accordingly, a method for video processing is described. One or more aspects of the method include obtaining an input prompt; generating, using a video generation model, a frame token based on the input prompt and a local subset of tokens from a global set of tokens corresponding to a set of video frames, wherein the local subset of tokens corresponds to a local window including a subset of video frames from the set of video frames, and wherein the frame token corresponds to a frame within the subset of video frames; generating, using the video generation model, an updated frame token based on the frame token and a different local subset of tokens from the global set of tokens, wherein the different local subset of tokens corresponds to a different local window having a window size different from the local window; and generating, using the video generation model, a video based on the updated frame token, wherein the video includes an image corresponding to each of the set of video frames. One or more aspects of the apparatus include generating a global token based on the input prompt and the global set of tokens, wherein the frame token is generated based on the global token.

### Computing Device

An exemplary embodiment of the present disclosure is configured to evaluate a performance of the video generation model. In some cases, the video generation model is configured to perform a non-overlapping windowed attention operation while varying a size of the window at different attention layers of the diffusion network. In some cases, the video generation model is configured to incorporate context from the nearby key frames and shifting windows between the attention layers of the diffusion network. For example, the video generation model of the present disclosure is able to significantly increase the speed of video generation (e.g., up to 2 times) based on the windowed attention operation.

FIG. 16 shows an example of a computing device according to aspects of the present disclosure. The computing device 1600 may be an example of the video processing apparatus 1700 described with reference to FIG. 17. In one aspect, computing device 1600 includes processor(s) 1605, memory subsystem 1610, communication interface 1615, I/O interface 1620, user interface component(s) 1625, and channel 1630.

In some embodiments, computing device 1600 is an example of, or includes aspects of, the video generation model of FIG. 17. In some embodiments, computing device 1600 includes one or more processors 1605 that can execute instructions stored in memory subsystem 1610 to perform media generation.

According to some aspects, computing device 1600 includes one or more processors 1605. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1610 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1615 operates at a boundary between communicating entities (such as computing device 1600, one or more user devices, a cloud, and one or more databases) and channel 1630 and can record and process communications. In some cases, communication interface 1615 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1620 is controlled by an I/O controller to manage input and output signals for computing device 1600. In some cases, I/O interface 1620 manages peripherals not integrated into computing device 1600. In some cases, I/O interface 1620 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1620 or via hardware components controlled by the I/O controller.

According to some aspects, user interface component(s) 1625 enable a user to interact with computing device 1600. In some cases, user interface component(s) 1625 include an audio device, such as an external speaker system, an external display device such as a display screen, an input device (e.g., a remote-control device interfaced with a user interface directly or through the I/O controller), or a combination thereof. In some cases, user interface component(s) 1625 include a GUI.

FIG. 17 shows an example of a video processing apparatus 1700 according to aspects of the present disclosure. Video processing apparatus 1700 is an example of, or includes aspects of, the corresponding element described with reference to FIGS. 1 and 3.

In one aspect, video processing apparatus 1700 includes processor unit 1705, memory unit 1710, I/O module 1725, and training component 1730. In one aspect, memory unit 1710 includes video generation model 1715 and text encoder 1720. Training component 1730 updates parameters of the video generation model 1715 and text encoder 1720 stored in memory unit 1710. In some examples, the training component 1730 is located outside the video processing apparatus 1700. According to some aspects, video processing apparatus 1700 obtains an input prompt describing a scene.

According to some aspects, processor unit 1705 comprises a processing device coupled to the memory component. Processor unit 1705 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1705 is configured to operate a memory array using a memory controller. In other cases, a memory controller is integrated into processor unit 1705. In some cases, processor unit 1705 is configured to execute computer-readable instructions stored in memory unit 1710 to perform various functions. In some aspects, processor unit 1705 includes special purpose components for modem processing, baseband processing, digital signal processing, or transmission processing. According to some aspects, processor unit 1705 comprises one or more processors described with reference to FIG. 16.

Memory unit 1710 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1705 to perform various functions described herein.

In some cases, memory unit 1710 includes a basic input/output system (BIOS) that controls basic hardware or software operations, such as an interaction with peripheral components or devices. In some cases, memory unit 1710 includes a memory controller that operates memory cells of memory unit 1710. For example, the memory controller may include a row decoder, column decoder, or both. In some cases, memory cells within memory unit 1710 store information in the form of a logical state. According to some aspects, memory unit 1710 is an example of the memory subsystem 1610 described with reference to FIG. 16.

According to some aspects, video processing apparatus 1700 uses one or more processors of processor unit 1705 to execute instructions stored in memory unit 1710 to perform functions described herein. For example, the video processing apparatus 1700 may obtain an input prompt describing a scene; generate, using a video generation model, a global token based on the input prompt by performing an attention process based on a plurality of frame tokens; generate, using the video generation model, a frame token by performing an attention process based on the global token and a subset of the plurality of frame tokens in a local window; and generate, using the video generation model, a synthetic video based on the frame token, wherein the synthetic video depicts the scene and includes an image frame corresponding to the frame token.

In one aspect, memory unit 1710 includes video generation model 1715 trained to obtain an input prompt describing a scene; generate, using a video generation model, a global token based on the input prompt by performing an attention process based on a plurality of frame tokens; generate, using the video generation model, a frame token by performing an attention process based on the global token and a subset of the plurality of frame tokens in a local window; and generate, using the video generation model, a synthetic video based on the frame token, wherein the synthetic video depicts the scene and includes an image frame corresponding to the frame token.

For example, after training, the video generation model 1715 may perform inferencing operations as described with reference to FIGS. 1-3 to obtain an input prompt describing a scene; generate, using a video generation model, a global token based on the input prompt by performing an attention process based on a plurality of frame tokens; generate, using the video generation model, a frame token by performing an attention process based on the global token and a subset of the plurality of frame tokens in a local window; and generate, using the video generation model, a synthetic video based on the frame token, wherein the synthetic video depicts the scene and includes an image frame corresponding to the frame token.

In some embodiments, the video generation model 1715 is an Artificial neural network (ANN) comprising a plurality of networks including the guided diffusion model described with reference to FIG. 6 and the transformer network described with reference to FIG. 5. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of video generation model 1715 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1730 may train the video generation model 1715 and text encoder 1720. For example, parameters of the video generation model 1715 and text encoder 1720 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 14). The goal of the training process may be to find optimal values for the parameters that allow the video generation model to make accurate predictions or perform well on the given task.

Additionally, in some aspects, training component 1730 tunes video generation model 1715 by updating one or more temporal layers. In some cases, the temporal layers generate latent embeddings that are influential on the motion features of the generated synthetic video. In at least one embodiment, training component 1730 is implemented on an apparatus different from video processing apparatus 1700.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the video generation model 1715 can be used to make predictions on new, unseen data (i.e., during inference).

According to some aspects, video generation model 1715 generates a global token based on the input prompt by performing an attention process based on a set of frame tokens. In some examples, video generation model 1715 generates a frame token by performing an attention process based on the global token and a subset of the set of frame tokens in a local window. In some examples, video generation model 1715 generates a synthetic video based on the frame token, where the synthetic video depicts the scene and includes an image frame corresponding to the frame token.

In some examples, video generation model 1715 generates the frame token including: performing an attention process based on a set of key frames corresponding to a set of frame blocks, respectively, where each of the set of frame blocks includes a unique subset of the set of frame tokens. In some examples, video generation model 1715 generates the frame token including: initializing a set of noisy frame tokens; and denoising the set of noisy frame tokens based on the global token to obtain the set of frame tokens.

In some examples, video generation model 1715 generates the synthetic video including: generating a set of image frames corresponding to the set of frame tokens. In some examples, video generation model 1715 identifies a diffusion timestep. In some examples, video generation model 1715 determines whether to perform selective attention for the frame token based on the diffusion timestep, where the selective attention is based on the local window.

According to some aspects, video generation model 1715 generates a frame token by performing an attention process based on the text token and a subset of a set of frame tokens in a local window. In some examples, video generation model 1715 generates a synthetic video based on the frame token, where the synthetic video depicts the scene and includes an image frame corresponding to the frame token. In some aspects, the video generation model 1715 includes a diffusion network.

Video generation model 1715 is configured to generate synthetic videos. Embodiments of video generation model 1715 include an image generation model such as a diffusion model that has been adapted to generate temporally coherent frames in a sequence. For example, the video generation model 1715 may include a diffusion model with additional temporal layers.

According to some aspects, text encoder 1720 generates a text token based on the input prompt, where the global token and the frame token are generated by performing an attention process based on the text token. In some cases, a text encoder is configured to process a textual input to generate a text token. The textual input may comprise natural language phrases, captions, sentences, or other structured or unstructured linguistic content. For example, the text encoder may include one or more neural network architectures such as transformer-based models (e.g., BERT, GPT, or CLIP), recurrent neural networks (RNNs), or convolutional networks adapted for text. The text encoder receives the text input and performs tokenization, embedding, and contextual encoding operations to generate corresponding text tokens. The text tokens may be represented as high-dimensional vectors capturing the semantic and syntactic properties of the input.

According to some aspects, a transformer comprises an encoder-decoder structure. The encoder of the transformer processes an input sequence and encodes the input sequence into a set of high-dimensional representations. The decoder of the transformer generates an output sequence based on the encoded representations and previously generated tokens. The encoder and the decoder each include one or more layers of self-attention mechanisms and feed-forward ANNs.

According to an embodiment, a windowed self-attention mechanism may refer to performing self-attention on a set of frames. For example, the windowed attention mechanism is performed on a current or local window. In some examples, each local window includes a partitioned video sequence comprising a set of video frames. In some examples, the windowed attention mechanism is performed to update the video frames within the local window.

In some cases, the self-attention mechanism is applied to an input feature sequence to enable the model to selectively emphasize contextually relevant portions of the input data. The self-attention module computes similarity scores between each token and all other tokens within the same input sequence, thereby generating attention weights that are used to reweight and aggregate the input features. This mechanism permits dynamic context modeling and improves feature representation by incorporating long-range dependencies. The input sequence may include image features, video frames, or tokenized data, and the resulting attention-enhanced representation supports tasks such as classification, generation, or alignment.

An attention mechanism is a key component in some ANN architectures that enables an ANN to selectively focus on different parts of an input sequence, assigning varying degrees of importance or attention to each part. The attention mechanism achieves the selective focus by considering a relevance of each input element with respect to a current state of the ANN.

According to some aspects, an ANN employing an attention mechanism receives an input sequence and maintains the current state, which represents an understanding or context. For each element in the input sequence, the attention mechanism computes an attention score that indicates the importance or relevance of that element given the current state. The attention scores are transformed into attention weights through a normalization process, such as applying a softmax function. The attention weights represent the contribution of each input element to the overall attention. The attention weights are used to compute a weighted sum of the input elements, resulting in a context vector. The context vector represents the attended information or the part of the input sequence that the ANN considers most relevant for the current step. The context vector is combined with the current state of the ANN, providing additional information and influencing subsequent predictions or decisions of the ANN.

By incorporating an attention mechanism, an ANN dynamically allocates attention to different parts of the input sequence, allowing the ANN to focus on relevant information and capture dependencies across longer distances.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt describing a scene;
generating, using a video generation model, a global token based on the input prompt by performing an attention process based on a plurality of frame tokens;
generating, using the video generation model, a frame token by performing an attention process based on the global token and a subset of the plurality of frame tokens in a local window; and
generating, using the video generation model, a synthetic video based on the frame token, wherein the synthetic video depicts the scene and includes an image frame corresponding to the frame token.

2. The method of claim 1, further comprising:
generating a text token based on the input prompt, wherein the global token and the frame token are generated by performing an attention process based on the text token.

3. The method of claim 1, wherein generating the frame token comprises:
performing an attention process based on a plurality of key frames corresponding to a plurality of frame blocks, respectively, wherein each of the plurality of frame blocks comprises a unique subset of the plurality of frame tokens.

4. The method of claim 1, wherein generating the frame token comprises:
initializing a plurality of noisy frame tokens; and
denoising the plurality of noisy frame tokens based on the global token to obtain the plurality of frame tokens.

5. The method of claim 1, further comprising:
iteratively updating the global token based on the frame token; and
iteratively updating the frame token based on the global token.

6. The method of claim 1, wherein generating the synthetic video comprises:
generating a plurality of image frames corresponding to the plurality of frame tokens.

7. The method of claim 1, further comprising:
identifying a diffusion timestep; and
determining whether to perform selective attention for the frame token based on the diffusion timestep, wherein the selective attention is based on the local window.

8. A non-transitory computer readable medium storing code for video processing, the code comprising instructions that, when executed by at least one processor, cause the at least one processor to perform operations comprising:
obtaining an input prompt describing a scene;
generating a text token based on the input prompt;
generating, using a video generation model, a frame token by performing an attention process based on the text token and a subset of a plurality of frame tokens in a local window; and
generating, using the video generation model, a synthetic video based on the frame token, wherein the synthetic video depicts the scene and includes an image frame corresponding to the frame token.

9. The non-transitory computer readable medium of claim 8, the code further comprising instructions that, when executed by the at least one processor, cause the at least one processor to perform operations comprising:
generating, using the video generation model, a global token based on the input prompt by performing an attention process based on the plurality of frame tokens, wherein the frame token is based on the global token.

10. The non-transitory computer readable medium of claim 8, wherein generating the frame token comprises:
performing an attention process based on a plurality of key frames corresponding to a plurality of frame blocks, respectively, wherein each of the plurality of frame blocks comprises a unique subset of the plurality of frame tokens.

11. The non-transitory computer readable medium of claim 9, wherein generating the frame token comprises:
initializing a plurality of noisy frame tokens; and
denoising the plurality of noisy frame tokens based on the global token to obtain the plurality of frame tokens.

12. The non-transitory computer readable medium of claim 9, the code further comprising instructions that, when executed by the at least one processor, cause the at least one processor to perform operations comprising:
iteratively updating the global token based on the frame token; and
iteratively updating the frame token based on the global token.

13. The non-transitory computer readable medium of claim 8, wherein generating the synthetic video comprises:
generating a plurality of image frames corresponding to the plurality of frame tokens.

14. The non-transitory computer readable medium of claim 8, the code further comprising instructions that, when executed by the at least one processor, cause the at least one processor to perform operations comprising:
identifying a diffusion timestep; and
determining whether to perform selective attention for the frame token based on the diffusion timestep, wherein the selective attention is based on the local window.

15. A system comprising:
a memory component; and
a processing device coupled to the memory component, the processing device configured to perform operations comprising:
obtaining an input prompt describing a scene;
generating, using a video generation model, a global token based on the input prompt by performing an attention process based on a plurality of frame tokens;
generating, using the video generation model, a frame token by performing an attention process based on the global token and a subset of the plurality of frame tokens in a local window; and
generating, using the video generation model, a synthetic video based on the frame token, wherein the synthetic video depicts the scene and includes an image frame corresponding to the frame token.

16. The system of claim 15, wherein:
the video generation model comprises a diffusion network.

17. The system of claim 15, further comprising:
a text encoder configured to generate a text token based on the input prompt, wherein the global token and the frame token are generated by performing an attention process based on the text token.

18. The system of claim 15, wherein generating the frame token comprises:
performing an attention process based on a plurality of key frames corresponding to a plurality of frame blocks, respectively, wherein each of the plurality of frame blocks comprises a unique subset of the plurality of frame tokens.

19. The system of claim 15, wherein generating the frame token comprises:
initializing a plurality of noisy frame tokens; and
denoising the plurality of noisy frame tokens based on the global token to obtain the plurality of frame tokens.

20. The system of claim 15, wherein generating the synthetic video comprises:
generating a plurality of image frames corresponding to the plurality of frame tokens.
